(19) United States
(12) Patent Application Publication
(10) Pub. No.: US 2009/0230768 A1
(43) Pub. Date: Sep. 17, 2009

(54) Method and Apparatus to Facilitate the Provision of Electrical Power As Pertains to a Self-Storage Facility

(75) Inventors: Robert Daniel-Wayman, Lombard, IL (US); Justen S. Ferguson, Peoria, AZ (US); James Joseph Fitzgibbon, Batavia, IL (US); Daniel M. Vincent, Phoenix, AZ (US)

Correspondence Address: FITCH EVEN TABIN & FLANNERY, 120 SOUTH LASALLE STREET, SUITE 1600, CHICAGO, IL, 60603-3406, US

(73) Assignee: The Chamberlain Group, Inc., Elmhurst, IL (US)

(21) Appl. No.: 12/346,228

(22) Filed: Dec. 30, 2008

Related U.S. Application Data
(60) Provisional application No. 61/037,205, filed on Mar. 17, 2008.

(51) Int. Cl. H02J 9/08; H02J 7/00

(52) U.S. Cl. 307/23; 320/101

(57) ABSTRACT

A self-storage facility having a variety of differing facility components (that utilize electricity) can couple those components to an electric mains to provide operating power. Upon sensing a lack of electrical power to that electric mains, however, these teachings can provide for actuating a back-up generator to provide back-up electrical power for some or all of those components. These teachings will also accommodate, if desired, using a renewable electrical source to provide the aforementioned electrical power to a disparate grouping of facility components. These teachings will also further accommodate, as desired, providing a source of direct current electrical power (such as a 48 volt direct current electrical power source) and then coupling that source to this disparate grouping of facility components to provide their required electrical power.

### RELATED APPLICATION(S)

This application claims the benefit of U.S. Provisional application No. 61/037,205, filed Mar. 17, 2008, which is incorporated by reference in its entirety herein.

This application is related to the following co-pending and co-owned U.S. patent applications that were filed on the same date as the present application:

U.S. patent application Ser. No. ______ (attorney's docket number 5569/93504), entitled METHOD AND APPARATUS TO FACILITATE CONTROLLING AN OVERLOCK AS PERTAINS TO A SELF-STORAGE FACILITY;

U.S. patent application Ser. No. ______ (attorney's docket number 5569/93505), entitled METHOD AND APPARATUS TO FACILITATE CONTROLLING LIGHTING AS PERTAINS TO A SELF-STORAGE FACILITY;

U.S. patent application Ser. No. ______ (attorney's docket number 5569/93688), entitled METHOD AND APPARATUS TO FACILITATE USING A CAMERA AS PERTAINS TO A SELF-STORAGE FACILITY;

U.S. patent application Ser. No. ______ (attorney's docket number 5569/93506), entitled METHOD AND APPARATUS TO FACILITATE RECEIVING AND PROCESSING STATUS INFORMATION AS PERTAINS TO A SELF-STORAGE FACILITY;

U.S. patent application Ser. No. ______ (attorney's docket number 5569/93507), entitled METHOD AND APPARATUS TO FACILITATE COMMUNICATING OPERATIONAL DATA AS PERTAINS TO A SELF-STORAGE FACILITY; all of which are incorporated in their entirety herein by this reference.

### TECHNICAL FIELD

This invention relates generally to self-storage facilities.

### BACKGROUND

Storage facilities of various kinds are known in the art. Most properties designed for human use make provision for the storage of items that are not presently being used. Homes and offices, for example, offer closets and cupboards for this purpose. In some cases the on-site storage space available to a given person or enterprise becomes inadequate to properly contain all such items. Third party off-site storage facilities serve to address such a need. In some cases, only authorized personnel for the off-site storage facility have access to the facility itself. In other cases, however, as with so-called self-storage facilities, it is the person storing the items who has direct ordinary access to that portion of the facility where their items are stored and typically not the party who owns the facility and who controls general access to the facility grounds.

Self-storage facilities typically comprise a plurality of individually physically separated storage units (sometimes of varying sizes) that are each individually accessible via a corresponding movable barrier. In many cases this movable barrier comprises a rolling-shutter style of garage door. In any event, the end user typically controls access to their individual storage unit by use of a corresponding end user-controlled lock (which may be provided by the facility or which may be provided by the end user as desired).

There are certain needs that tend to commonly apply to self-storage facilities regardless of various differences that may apply with respect to their design and approach. For example, such a facility needs to provide security. Such a facility should also offer convenient access to the authorized end users of the facility. At the same time, however, such a facility will usually be required to minimize operating expenditures. This interest often leads to only a minimal on-site human presence on behalf of the facility itself; in fact, some facilities are going without human personal except for occasional maintenance, responding to security incursions, or the like. This interest, however, can undercut the goals of bolstering security and accessibility. There are numerous other examples of conflicting needs and requirements that tend to characterize the design and operation of self-storage facilities.

Numerous such conflicts exist, for example, with respect to the provisioning of a self-storage facility with sufficient electrical power to ensure the operability of the various electrical and electro-mechanical components as comprise such a system. On the one hand, for example, automation tends to encourage the use of such components. On the other hand, powering such components can significantly increase the installation costs and on-going operating costs of such a facility.

### BRIEF DESCRIPTION OF THE DRAWINGS

The above needs are at least partially met through provision of the method and apparatus to facilitate the provision of electrical power as pertains to a self-storage facility described in the following detailed description, particularly when studied in conjunction with the drawings, wherein:

FIG. 1 comprises a top plan schematic view as configured in accordance with the prior art;

FIG. 2 comprises a front elevational detail view as configured in accordance with the prior art;

FIG. 3 comprises a flow diagram as configured in accordance with various embodiments of the invention;

FIG. 4 comprises a block diagram as configured in accordance with various embodiments of the invention;

FIG. 5 comprises a flow diagram as configured in accordance with various embodiments of the invention;

FIG. 6 comprises a block diagram as configured in accordance with various embodiments of the invention;

FIG. 7 comprises a flow diagram as configured in accordance with various embodiments of the invention;

FIG. 8 comprises a block diagram as configured in accordance with various embodiments of the invention;

FIG. 9 comprises a flow diagram as configured in accordance with various embodiments of the invention;

FIG. 10 comprises a block diagram as configured in accordance with various embodiments of the invention;

FIG. 11 comprises a block diagram as configured in accordance with various embodiments of the invention;

FIG. 12 comprises a flow diagram as configured in accordance with various embodiments of the invention;

FIG. 13 comprises a block diagram as configured in accordance with various embodiments of the invention;

FIG. 14 comprises a flow diagram as configured in accordance with various embodiments of the invention;

FIG. 15 comprises a flow diagram as configured in accordance with various embodiments of the invention;

FIG. 16 comprises a block diagram as configured in accordance with various embodiments of the invention;

FIG. 17 comprises a front elevational schematic view as configured in accordance with various embodiments of the invention;

FIG. 18 comprises a flow diagram as configured in accordance with various embodiments of the invention;

FIG. 19 comprises a block diagram as configured in accordance with various embodiments of the invention;

FIG. 20 comprises a top plan schematic view as configured in accordance with various embodiments of the invention;

FIG. 21 comprises a flow diagram as configured in accordance with various embodiments of the invention;

FIG. 22 comprises a flow diagram as configured in accordance with various embodiments of the invention;

FIG. 23 comprises a flow diagram as configured in accordance with various embodiments of the invention;

FIG. 24 comprises a flow diagram as configured in accordance with various embodiments of the invention;

FIG. 25 comprises a block diagram as configured in accordance with various embodiments of the invention; and

FIG. 26 comprises a top plan schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Prior to presenting details as pertain to the various inventions described herein, it may be helpful to first briefly describe and characterize an illustrative self-storage facility 100. This self-storage facility 100 comprises a plurality of individual self-storage units 101 (denoted as “Unit 1” through “Unit 24” in this example, though those skilled in the art will understand that such a facility can readily accommodate some lesser or greater number of self-storage units). In this particular example, the self-storage facility 100 comprises six separate buildings 102 that each contain four such self-storage units 101. Each of the self-storage units 101 is physically separated from adjacent units by the use of walls and ceilings.

With momentary reference to the prior art diagram of FIG. 2, a movable barrier 201 provides access to each such self-storage unit 101. Each such barrier 201, in turn, accommodates a corresponding end user (and sometimes facility)-controlled lock 202. These can include, for example, key-operated and combination-based locks as are known in the art. This lock 202 also comprises, in this illustrative example, an overlock mechanism that is controllable by authorized personnel for the self-storage facility 100. Such overlooks are known in the art and include both simple mechanical approaches (that permit, for example, a second key or combination-based lock to be placed on the barrier 201) as well as remotely-controlled electrically-operated locking and unlocking mechanisms. Some specific approaches in this regard can be found at U.S. Pat. Nos. 7,236,085 and 7,221,273 and pending U.S. patent application Ser. No. 11/095,874, the contents of which are incorporated herein by this reference.

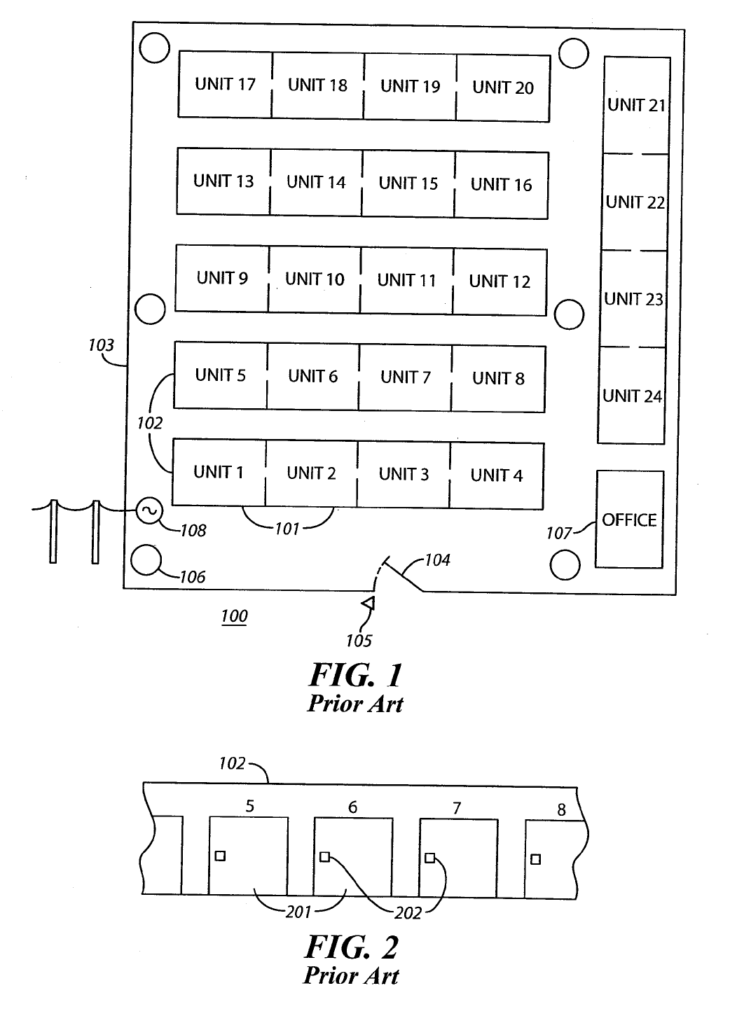

Referring again to FIG. 1, such a self-storage facility 100 also typically includes a perimeter barrier 103 such as a fence. This perimeter barrier 103 will usually include at least one (and often only one) point of access 104. This point of access 104 will often comprise an automatically controlled sliding gate 104 that responds to an access-control mechanism 105 of choice. By one typical approach, for example, the access-control mechanism 105 comprises a keypad that the end user employs to enter an entry code. Correct entry of this entry code, in turn, causes the access-control mechanism 105 to instigate moving the gate 104 and hence permitting the end user to enter the premises.

A typical self-storage facility 100 will also usually include electric lighting. This often at least includes security lighting 106 (where “security lighting” will be understood to refer to lighting that serves, at least primarily, to provide illumination in a manner that will tend to deter unauthorized individuals from occupying the illuminated space in order to avoid having their unauthorized presence noted by an observer). Such security lighting 106 is often located near the periphery of the self-storage facility 100 as well as at appropriate locations within the facility 100. A given facility 100 will also often including other kinds of lighting including but not limited to workspace lighting (to provide helpful illumination to authorized end users who are there to locate their units, to place items in or to remove items from their units, to inspect the contents of their units, and so forth), illuminated signage, illuminated instructions (such as EXIT signs), and so forth.

As shown in FIG. 1, a typical self-storage facility 100 also often includes an office 107. This office serves as a workplace for one or more authorized representatives of the self-storage facility 100. Such persons are often there to interact with existing end users (by, for example, accepting monthly rental payments, addressing access problems, and so forth) and potential new end users (by, for example, having new end users sign rental agreements), to monitor the security of the premises (by, for example, making personal inspections, observing closed circuit video feeds that provide views of various locations within the facility, monitoring sensors such as smoke detectors, and so forth), and so forth.

Such a facility 100 is typically served with an electric mains that provides 120 (and/or 240) volts of alternating current service (in the United States, with other kinds of comparable service being available in other countries) to power the aforementioned lighting, point-of-entry gate, and so forth. The facility infrastructure may also include various kinds of data cabling (such as coaxial cable, CAT 5 or 6 cabling, or the like) to accommodate various data feeds as may be used to accommodate security cameras, smoke detectors, remotely controlled overlooks, and so forth.

Generally speaking, pursuant to these various embodiments, a self-storage facility having a variety of differing facility components (that utilize electricity) can couple those components to an electric mains to provide operating power. Upon sensing a lack of electrical power to that electric mains, however, these teachings can provide for actuating a back-up generator to provide back-up electrical power for some or all of those components. These teachings will also accommodate, if desired, using a renewable electrical source to provide the aforementioned electrical power to a disparate grouping of facility components. These teachings will also further accommodate, as desired, providing a source of direct current electrical power (such as a 48 volt direct current electrical power source) and then coupling that source to this disparate grouping of facility components to provide their required electrical power.

So configured, some or all of these teachings can be deployed to ensure the provision of operating electrical power in a way that best suits local requirements and/or opportunities in a cost-effective manner. This can include, for example, suitable combinations of grid-based power, renewal electrical power sources, back-up electrical power, and/or direct current electrical power.

These and other benefits may become clearer upon making a thorough review and study of the following detailed description. As noted above, this application presents a number of different inventive concepts. For ease of reference, titled sections are utilized to segregate, to some extent, corresponding descriptions and discussions. Notwithstanding the use of these titles, those skilled in the art will understand that these lines of demarcation are not intended to necessarily circumscribe one invention from another nor to suggest that a given invention might not comprise various permutations and/or combinations of the content set forth in various ones of these sections.

Facility Power Infrastructure

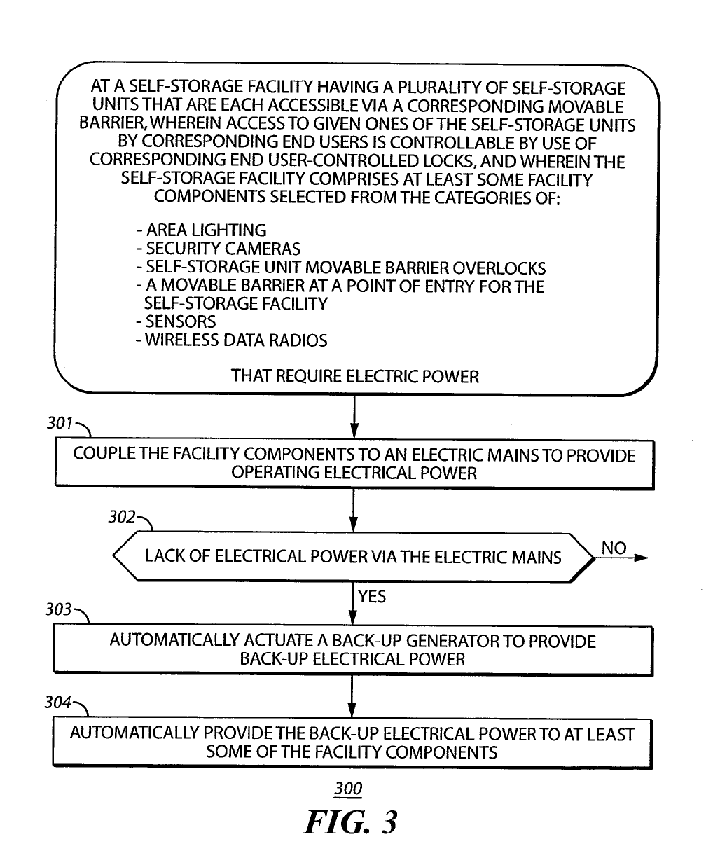

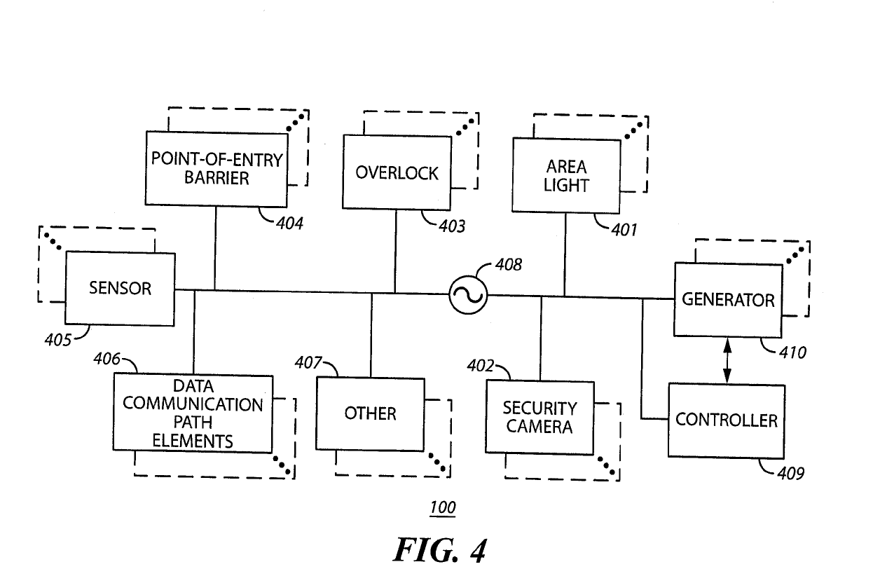

Referring now to FIGS. 3 and 4, a given process 300 finds particular use at a self-storage facility having a plurality of self-storage units that are each accessible via a corresponding movable barrier and wherein access to given ones of these self-storage units by corresponding end users is controllable by use of corresponding end user-controlled locks. For the sake of example this process 300 will also be set forth in conjunction with a self-storage facility that includes at least some facility components that are selected from the categories of area lighting 401 (such as, but not limited to, security lighting, workspace lighting, interior and exterior lighting, signage lighting, decorative lighting, and so forth), security cameras 402 (including both single-frame and video cameras, color and monochromatic cameras, digital and film-based cameras, ordinary light and infrared-light cameras, statically-aimed and dynamically-aimable cameras, and so forth), self-storage unit movable barrier overlooks 403, an operator 404 for a movable barrier at a point-of-entry for the self-storage facility, one or more sensors 405 (such as, but not limited to, motion sensors, temperature sensors, tamper detectors, smoke detectors, airborne-chemical sensors, light sensors, weight sensors, audio sensors, human-proximity sensors, weather-condition sensors, and so forth), data communications path elements 406 (such as, but not limited to, wireless data radios, repeaters, and so forth), and such other components 407 as may be useful or required to suit the needs and requirements of a given application setting, wherein such facility components require electrical power to operate.

As noted, the self-storage facility includes at least some of these facility components. The particular categories represented in a given instance can and will vary with the needs and/or opportunities as tend to characterize a given application setting. By one approach, for example, the self-storage facility can comprise facility components selected from at least three of these categories. As another example, the self-storage facility can comprise facility components selected from at least four of these categories (such as lighting, cameras, overlooks, and a point-of-entry operator). And as yet another example, the self-storage facility can comprise facility components that are selected from each of these categories.

This process 300 provides for the step 301 of coupling these facility components to an electric mains 408 to thereby provide operating electrical power to such components. (The expression “mains” will be understood to refer to a supply of general purpose alternating current (AC) electrical power. Other common expressions for a same supply are household power, household electricity, domestic power, wall power, line power, AC power, city power, and grid power.)

In this illustrative example, a controller 409 then serves to effect the step 302 of automatically sensing a lack of electrical power via the electric mains 408. This can comprise, for example, acting to make such a determination on a periodic basis (such as, for example, once every tenth of a second, once a second, once a minute, and so forth as desired). In the alternative, if desired, this step 302 can be realized by use of a real-time interrupt technique as is known in the art. In the absence of such an interruption, those skilled in the art will understand and recognize that the controller 409 can engage in such other activities as may be desired and appropriate to the needs of the application setting.

Upon detecting this lack of electrical power from the electric mains 408, this process 300 then provides the step 303 of automatically actuating a back-up generator 410 to provide back-up electrical power and the step 304 of providing this back-up electrical power to at least some of the facility components. In the illustrative example shown in FIG. 4, the back-up power is provided to all of the facility components.

By one approach, there can be a plurality of back-up generators 410. In such a case, these steps can comprise actuating some, or all, of these back-up generators 410 as needed or as desired to meet present (or anticipated) loading requirements. By another approach, if desired, the back-up electrical power from a first such back-up generator 410 can be provided to a first group of the facility components (such as, for example, the area lights 401) while the back-up electrical power from a second such back-up generator 410 can be provided to a second group of the facility components that is different from the first group of facility components (such as, for example, overlooks 403 and a point-of-entry barrier operator 404). Those skilled in the art will recognize that other possibilities are possible in these regards as well and that these particular examples are only intended to serve in a non-limiting illustrative capacity.

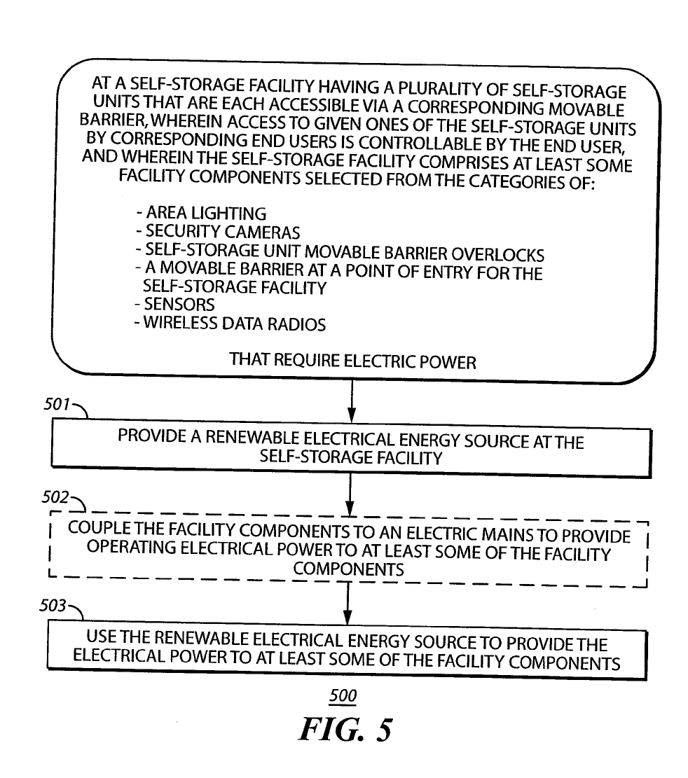

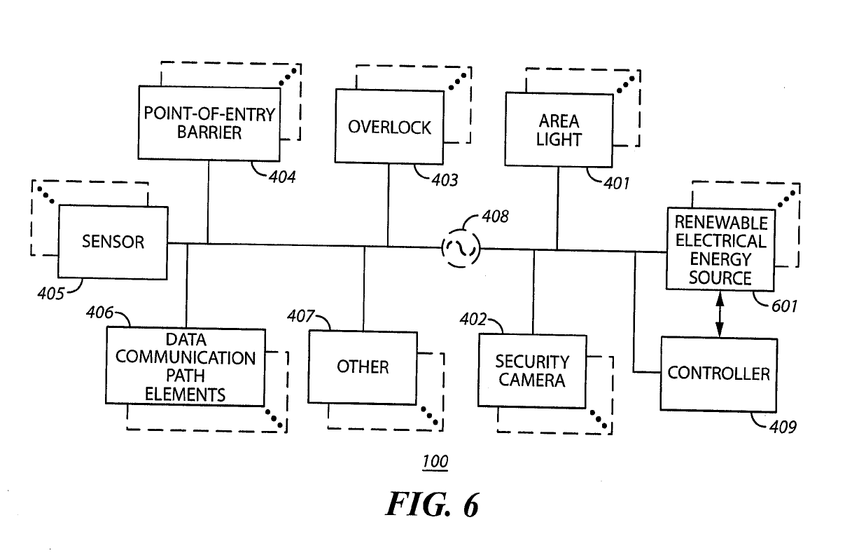

Referring now to FIGS. 5 and 6, another potentially related process 500 for application in a similar application setting includes the step 501 of providing a renewable electrical energy source 601 at the self-storage facility. As used herein, the expression “renewable electrical energy source” will be understood to refer to an energy source that is locally renewable and that does not use vegetable matter (such as wood) as a fuel. By one approach, for example, this renewable electrical energy source 601 can comprise a photonically-based renewable electrical energy source such as one or more arrays of solar cells. Such arrays can be placed, for example, upon the roofs of the buildings 102 that house the individual self-storage units 101 as comprise the self-storage facility 100. As another non-limiting example in these regards, the renewable electrical energy source 601 can comprise a wind-based renewable electrical energy source. Wind-powered generators can serve in this regard, for example. It would also be possible to utilize two or more different kinds of renewable electrical energy sources, either in tandem or as alternatives to one another.

Those skilled in the art will recognize that there are numerous available technologies to employ as a renewable electrical energy source. It will further be understood that further alternatives are likely to be developed going forward. As the present teachings are not particularly sensitive to the selection of any particular approach in these regards, further elaboration with respect to these technologies will not be presented here for the sake of brevity.

In any event, in many application settings this step 501 will likely include storing energy from the renewable electrical energy source in one or more batteries and then selectively coupling the latter to the facility components in order to provide operating electrical power. By one approach, such a battery, when present, can receive charging energy from only the renewable electrical energy source itself and not from another source such as, for example, the electric mains. Again, various embodiments to achieve this result are well known in the art and require no further discussion here.

This process 500 will optionally accommodate the additional step, if desired, of coupling the facility components to the aforementioned electric mains 408 to thereby use the latter as a source of operating electrical power. Such an electric mains 408, when present, can either serve as an ordinary and usual source of power (in which case the renewable electrical energy source 601 can serve as a stand-by power source) or can serve as a stand-by power source when the renewable electrical energy source 601 fails to provide adequate power. These teachings will also accommodate using the electric mains 408 to ordinarily power a first group of facility components while the renewable electrical energy source 601 serves to ordinarily power a second, different group of facility components.

In any event, this process 500 also provides the step 503 of using the renewable electrical energy source 601 to provide the necessary operating electrical power to at least some of the facility components. By one approach, for example, this might comprise providing operating power to components from at least three of the aforementioned component categories. As another example, this might comprise providing operating power to components from four such categories or even to components from all of the aforementioned component categories.

As noted above, if desired, an electric mains 408 can optionally serve as a primary and ordinary source of operating power for the facility components. In such a case, the controller 409 can serve to detect when power from the electric mains 408 fails for whatever reason and to then responsively couple, for example, the aforementioned battery (or batteries) to the affected facility components to thereby provide the operating electrical power.

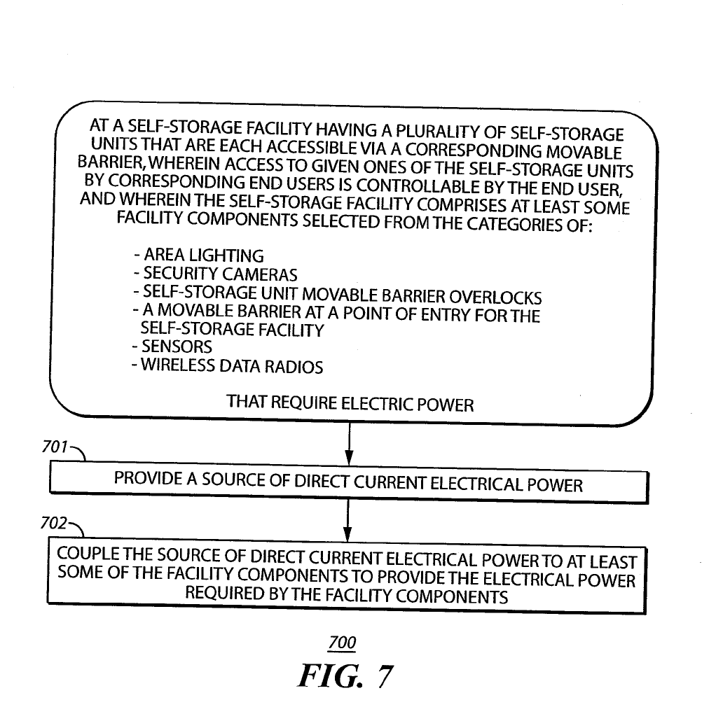

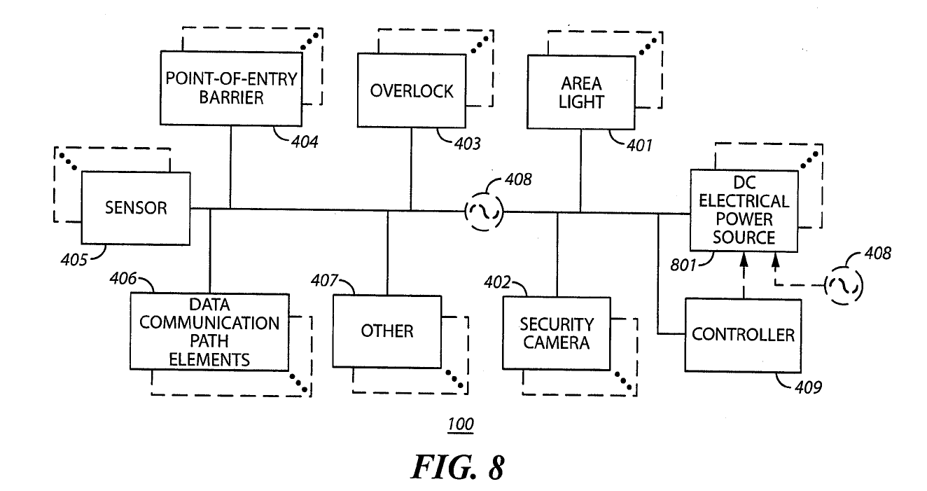

In the examples provided above, the electrical infrastructure of the self-storage facility 100 presumes use of alternating current (as provided by an electric mains, a generator, and/or a renewable electrical energy source). Referring now to FIGS. 7 and 8, however, these teachings will also accommodate a process 700 that includes the step 701 of providing a source of direct current electrical power 801 and the step 702 of coupling that source of direct current electrical power 801 to the various facility components to thereby provide their electrical power requirements. As used in this context, this notion of coupling the source of direct current electrical power 801 to the facility components will be understood to comprise providing that direct current without inversion into an alternating current form. Instead, pursuant to this particular approach, the various facility components are themselves selected and configured to operate directly using direct current.

By one approach, and so configured, the self-storage facility 100 can lack an electric mains 408. By another approach, such an electric mains 408, when present, can serve to provide a source of energy for the direct current electrical power source 801. These teachings will also readily accommodate using a generator and/or the aforementioned renewable energy source(s) as a source of energy to be used by the direct current electrical power source, either alone or in combination with an electric mains.

By one approach, such a direct current electrical power source 801 can comprise a source of 48 volt direct current electrical power. This comprises a well-known level with considerable existing component support to ease the use of such an approach in a given application setting. Those skilled in the art will recognize and appreciate that wiring an entire self-storage facility 100 to utilize 48 volts of direct current electricity, as versus standard alternating current electricity, could greatly reduce the cost of initial installation as safety and code requirements and needs are greatly reduced when working with such electricity. Those skilled in the art will also recognize and appreciate that the suggested level of 48 volts serves an illustrative purpose and that the voltage level can be reduced to any level that is appropriate to suit the needs of a given application setting. It will further be understood and appreciated that such an approach will mesh well with the use of renewable electrical energy sources as the energy for such sources is often stored in a battery and initially retrieved in a direct current form.

Facility Communications

As noted above, a self-storage facility 100 can comprise a large number of facility components. This can include a large number of components as belong to a common category (such as a large number of lights) and/or components from a large number of different categories. Also as noted above, such a self-storage facility 100 can also comprise a controller 409 (that might be located, for example, in the aforementioned office 107 though numerous other locations, both on and off the facility premises, are possible as desired. This controller can also consist of a number of sub-systems including a personal computer, a special-purpose controller, a radio receiver, and so forth). In such a case, these teachings will readily accommodate (and, in fact, endorse) placing the control of some or all of the facility components under this controller 409. Such a configuration provides a highly leverageable facility with a few particularly useful possibilities in these regards being noted further below.

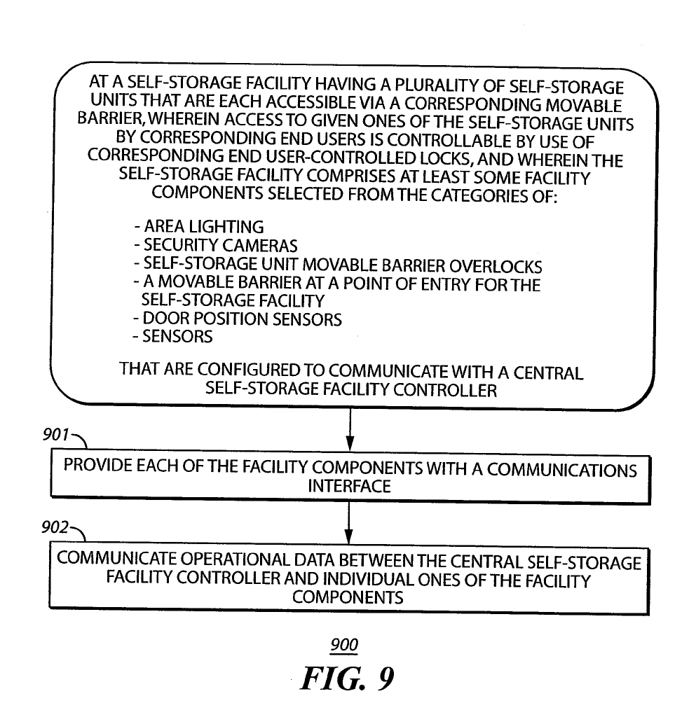

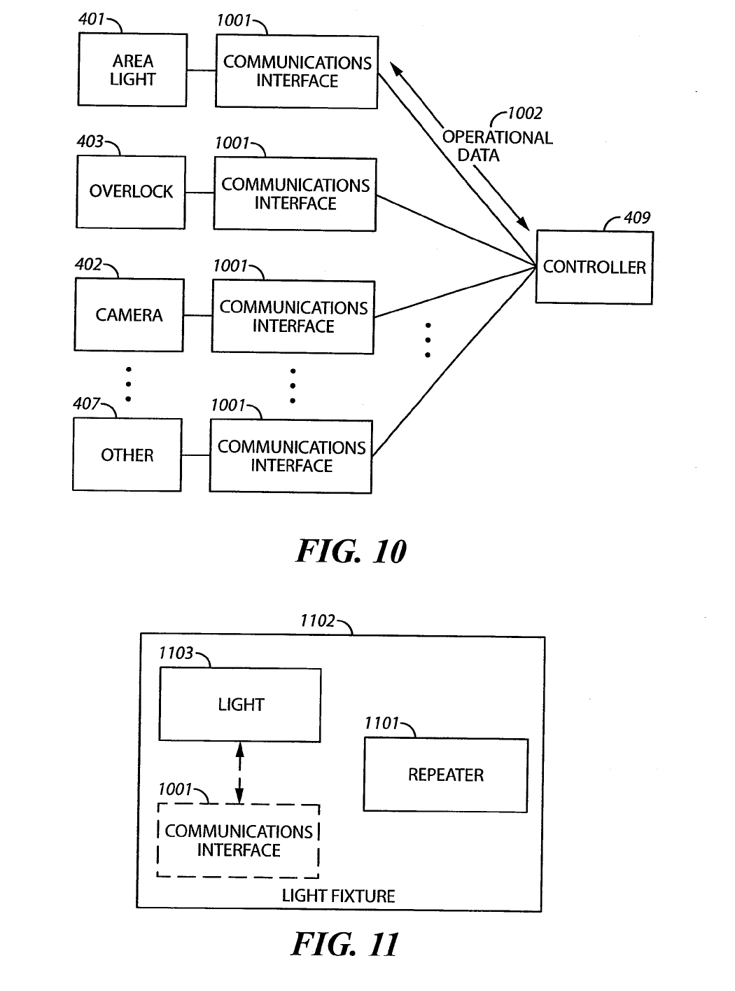

In order to facilitate such a configuration, however, the controller 409 must, in fact, be communicatively coupled to these various facility components. Referring now to FIGS. 9 and 10, an illustrative approach in these regards will be described.

This illustrative process 900 again presumes a self-storage facility as has been characterized above and where the facility components themselves are configured to be able to communicate with a central self-storage facility controller. This can be as modest or as sophisticated a communication capability as may be desired. In any event, this process 900 provides the step 901 of providing each of these facility components with a communications interface 1001 to thereby realize the desired communicative coupling to the controller 409.

By one approach, these communications interfaces 1001 can comprise non-wireless communications interfaces. In such a case, the interfaces 1001 might be expected to connect to the controller 409 via a physical conduit such as an electrical conductor (or conductors) or an optical conduit such as one or more optical fibers. This conduit can be dedicated to this purpose (as when using, for example, a twisted pair of conductors) or might comprise a multi-purpose conduit (as when the electrical conductor also serves to carry electrical power). Numerous examples are known in these regards all of which have the commonality of allowing communication.

By another approach, these communications interfaces 1001 can comprise wireless communications interfaces. In such a case, the interfaces 1001 might be expected to connect to the controller 409 via a wireless carrier such as a radio frequency carrier (or carriers), a light frequency carrier, or even an audible (or sub-audible) frequency carrier. When using wireless interfaces, the coverage range can of course vary to suit the needs and/or opportunities of a given application setting. In some cases, for example, these wireless interfaces can comprise short-range communications interfaces (being generally effective no further, for example, than 10 meters (as with Bluetooth enabled approaches), 100 meters (as with many cordless microphone approaches), 300 meters, and so forth). In other cases, longer ranges may be necessary.

It is not necessary that all of the communications interfaces 1001 be identical to one another at a given facility. Some, for example, may be wireless while others are non-wireless. It is also possible that these interfaces 1001 vary with respect to their fundamental communications capabilities. For example, in some cases, the communications interface 1001 may only comprise a receiver. Such a device may be useful with, for example, area lighting 401 as it may only be useful or necessary to have the lighting receive operational commands from the controller 409. In other cases, the communications interface 1001 may only comprise a transmitter. Such a device may be useful with, for example, sensors 405 as it may only be useful or necessary to have the controller 409 receive the sensor information. And in yet other cases, the communications interface 1001 may comprise a transceiver that is capable of supporting two-way transmissions between the facility component and the controller 409 (to allow, for example, at a minimum, acknowledgment of the reception of an inbound transmission).

Generally speaking, these communication interfaces 1001 are configured in a manner that is suitable to ensure compatible interaction between these components of the facility 100. This can comprise, for example, selecting an appropriate modulation technique, error detection and/or correction methodology, encryption technique, and so forth. By one approach, for example, it may be desirable to employ so-called rolling code techniques as are known in the art to protect the integrity and security of these communications. This can aid in preventing an electronic eavesdropper from monitoring an “open” command as transmitted by the controller 409 to a point-of-entry movable barrier operator 404 and then attempting to reuse that command to cause the point-of-entry movable barrier operator 404 to open without actual official authorization.

In any event, this process 900 also includes the step 902 of communicating operational data 1002 between the controller 409 and individual ones of the facility components. This can comprise individually-directed communications (using, for example, a unique address identifier for each of the individual facility components), group-directed communications (where, for example, a category or group identifier is used to permit all lights to be activated with a single broadcast command), or general broadcasts that are directed to all of the facility components.

As noted above, in some cases these communications interfaces 1001 may comprise short-range platforms. It is therefore possible that such an interface 1001 may be positioned within a facility 100 at a location that is too far from the controller 409 to ensure reliable reception. In such a case, the data communications path elements 406 for a given self-storage facility 100 can also comprise one or more wireless repeaters. By one approach, this capability can be built into the communications interfaces 1001 themselves. So configured, such an interface 1001 can serve to transmit both the messages that are sourced by their corresponding facility component as well as messages that are received from other communications interfaces 1001 for other facility components.

By another approach, these repeaters can comprise dedicated platforms that do not serve another function. In this regard, and referring momentarily to FIG. 11, a repeater can be co-located with other facility components if desired. In the illustrative example provided, such a repeater 1101 is co-located with a light 1103 inside of the light fixture housing 1102 (where the light 1103 itself may, for example, be coupled to its own communications interface 1001 as per the teachings set forth above). By this approach, repeaters can be readily and easily distributed about a self-storage facility as a natural result of installing other facility components that are a normal and expected part of such a facility.

System Integrity

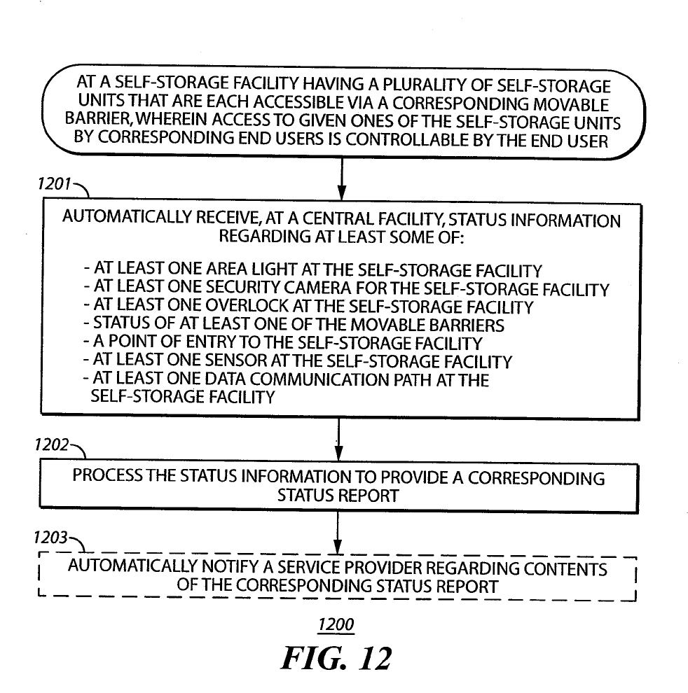

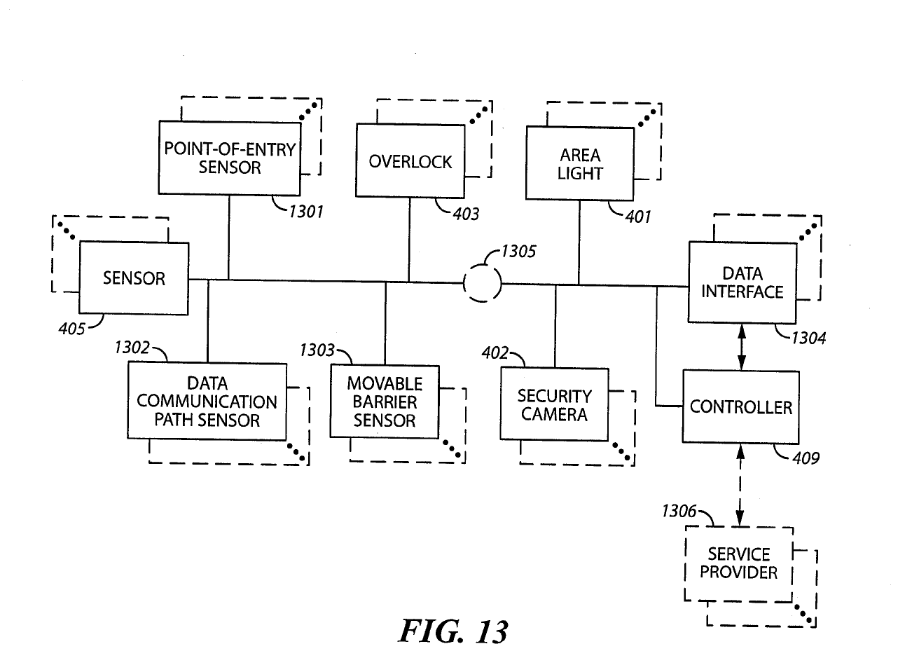

The numerous benefits of such a configuration, of course, are obtained with some concession to complexity. This complexity, in turn, has the potential to present certain maintenance and servicing challenges. With this in mind, and referring now to FIGS. 12 and 13, a process and corresponding apparatus to address such a need will be described.

This process 1200 includes a step 1201 of automatically receiving, at a central facility such as, for example, the aforementioned controller 409 (and via, for example, the previously described communications network and particularly via, as appropriate, a corresponding data interface 1304 for the controller 409) status information regarding at least some of the aforementioned facility components. This can comprise, for example, status information regarding at least one area light 401 at the self-storage facility (such as status information regarding the present illumination state of the light, present operability of the light, and so forth), status information regarding at least one security camera 402 for the self-storage facility (such as a present operability state, availability of operating power, operability of a zoom capability, operability of a panning capability, and so forth), and/or status information regarding at least one overlock 403 at the self-storage facility (such as a locked state, an unlocked state, local temperature at the overlock, and so forth).

Other possibilities of course exist. This status information might also comprise status information from a corresponding sensor 1303 regarding the status of at least one of the movable barriers as corresponds to given ones of the self-storage units (such as an opened/closed status of the barrier, a moving-towards-a-closed-position status of the barrier, a moving-towards-an-opened-position status of the barrier, and so forth), status information regarding a point of entry to the self-storage facility (such as whether the point-of-entry barrier is opened or closed) as provided by a point-of-entry sensor 1301, and status information as might be provided by any number of other sensors 405 as may be provided at the self-storage facility.

As noted earlier, these sensors 405 can include weather condition sensors (such as temperature sensors, wind sensors, precipitation sensors, ice-formation sensors, and so forth), tamper sensors (to detect, for example, unauthorized efforts to improperly enter a self-storage unit or to defeat a locked overlock), weight sensors (as used, for example, to detect the weight of a vehicle prior to that vehicle entering the premises of the self-storage facility, and so forth. This process 1200 will also support, if desired, automatically receiving status information regarding at least one data communication path (as provided, for example, via one or more data communication path sensors 1302). This can comprise, for example, status information regarding data path integrity, a lack of (or the presence of) interference, bit error rates, signal-to-noise information, repeater availability, data traffic level, and so forth.

The specifics of this step 1201 will vary with the details of a given application setting. By one approach, for example, this step 1201 can comprise having the controller 409 automatically pulling this status information from corresponding sources. This can comprise using a polling protocol of choice by which the controller 409 polls the status information sources, one-by-one, to prompt the transmission of their respective data. As another related approach, the controller 409 can prompt a group of these sources (such as all area lights 401) to provide their status information using a pseudo-random timing variable to thereby avoid timing collisions with one another when responding.

By another approach, alone or in conjunction with a pull approach, this step 1201 can comprise having the information sources push their status information to the controller 409 without prior prompting. This can comprise having the information sources make a real time or near-real time push when status changes occur and/or making a scheduled transmission of status information on some regular periodic basis (such as every five minutes, every hour, once a day, or such other interval as meets the needs of a given application setting).

As noted above, this step 1201 provides for receiving status information from at least some of these information sources. This can comprise, for example, receiving status information from three such categories of information sources, or five such categories, or from all of the available information sources, to note just a few examples in these regards.

Generally speaking, this status information can comprise, at least in part, information regarding the operational integrity of a corresponding source of such information. This can comprise present operational integrity and/or future operational integrity as desired and possible.

This process 1200 then provides the step 1202 of processing this received status information (again at the controller 409 if desired) to provide a corresponding status report. By one approach this report can essentially note each information source and its present status data. By another approach, such a report can be supplemented with additional historical content (such as, for example, status data for a specific number of previous reports or for some particular period of time). It would also be possible to provide a more abbreviated report that includes and only presents status information that represents a change or only status information that reflects a likely problem with operational integrity. Numerous other report possibilities are known in the art that may be similarly applied in these circumstances.

By one approach, this status report can simply be stored and archived. This can comprise storing the information locally (for example, at the office of the self-storage facility). This can also comprise, if desired, storing the information remotely using, for example, a memory that is located miles away from the self-storage facility and that is accessed using a network such as the Internet.

This process 1200 will also optionally accommodate the step 1203 of automatically notifying a service provider 1306 (or service providers) regarding the contents of the status report. These service providers 1306 can comprise, for example, third parties that provide service and maintenance for various facility components (such as a lighting service and repair enterprise, a security camera service and repair enterprise, and so forth). This step 1203 of automatically notifying the service provider 1306 can comprise the use of any number of communication mechanisms including but not limited to email (using, for example, previously formed textual messages to present the status information of concern), short message services (SMS), texting, a synthesized voice message, a pre-recorded voice message, a facsimile transmission, a popup message, and so forth.

When providing this status information, these teachings will also accommodate providing, in that same communication or in a later communication, a code (such as a number or alphanumeric sequence). In such a case, these teachings will also accommodate detecting (via, for example, the aforementioned controller 409) when an agent of the service provider 1306 presents this code at the self-storage facility (using, for example, a gate control fixture at a point-of-entry gate) and then automatically responding by taking at least one predetermined action (such as, for example, automatically admitting the agent into the self-storage facility by opening the point-of-entry barrier). Other automated responses can be undertaken as well. For example, and as will be described below in more detail, lighting at the facility can be controlled to aid in directing this agent to a status information source that requires the maintenance attention.

As noted above, a fully-configured self-storage facility can comprise potentially hundreds or even thousands of individual facility components. Maintaining computer application configuration information for these facility components can therefore present, in and of itself, a considerable challenge. Such configuration information can comprise, but it certainly not limited to, plain-English identifiers for each facility component (such as, for example, “Northwest corner security light”), network addresses and/or identifiers for each facility component, group identifiers that associate a given facility component with a particular category or group of components, encryption key information and/or rolling code information to be employed when communicating with a given facility component, communications protocol specifics to be employed when communicating with a given facility component, and so forth. Generally speaking, such configuration information typically comprises information that directly or indirectly assists the controller 409 with respect to communicating with and managing the operation of these various facility components.

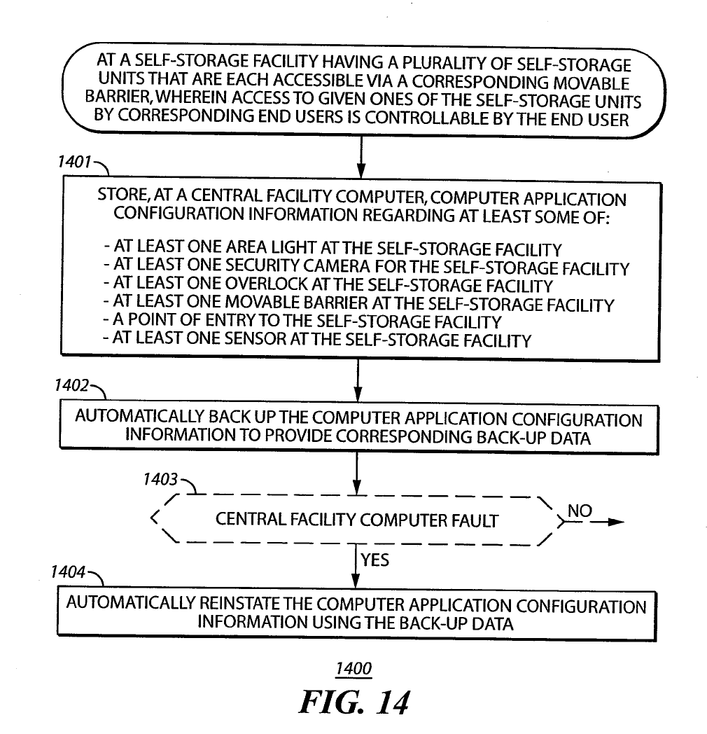

Such configuration information will typically be stored at, or with, such a controller 409. Unfortunately, various problems can arise that threaten the integrity of this information. Power surges, mechanical failures, vandalism, electromagnetic influences, undue temperature excursions, and so forth can all lead to a loss of such information. Referring now to FIG. 14, a process 1400 to address such a need includes the step 1401 of storing, at a central facility computer (such as the aforementioned controller 409), computer application configuration information regarding at least some of at least one area light at the self-storage facility, at least one security camera for the self-storage facility, at least one overlock at the self-storage facility, at least one movable barrier at the self-storage facility (which can include, for example, a movable barrier operator as corresponds to that movable barrier), a point of entry to the self-storage facility, and at least one sensor at the self-storage facility, to note but a few salient examples in these regards. This step 1401 can comprise storing, for example, computer application configuration information for facility components from three of these categories, from five of these categories, from all of these categories, or otherwise as suits the needs of a given application setting.

This step 1401 of storing such information can comprise a batch storage activity and/or can comprise an incremental process where such information is stored in this manner upon receipt. By one approach, this step 1401 can occur as the information is pushed to the controller 409 by the corresponding information sources and/or when and as the controller 409 pulls such information from the information sources using, for example, a polling technique of choice.

This process 1400 then provides the step 1402 of automatically backing up this computer application configuration information to provide corresponding back-up data. By one approach, this can comprise backing up this information to an on-site storage facility. This on-site storage facility can comprise resources located within the controller 409 itself or can comprise a physically separate and discrete memory. By another approach, this step 1402 can comprise backing up this information to an off-site storage facility (where “off-site” will be understood to refer to a storage platform that is physically removed from the self-storage facility). This could comprise, for example, using a storage platform that is accessed via a network such as the Internet. This step 1402 will also accommodate using both on-site and off-site resources to store some or all of the computer application configuration information.

As with the initial storage step 1401, this step 1402 of backing up the stored information can occur more-or-less in real time as the information becomes stored and/or on some batch-processing basis. The latter approach can comprise, for example, backing up the information on a scheduled basis (such as once every hour, once every day, once every week, or pursuant to any other schedule that may be desired).

This back-up information can then be used as appropriate. For example, by one approach, this process 1400 will optionally accommodate the step 1403 of detecting a fault with the aforementioned central facility computer (which can include, if desired, the working memory that contains the configuration information being used by that platform) and then responsively effecting the step 1404 of automatically reinstating the computer application configuration information using the back-up data. By this approach, the configuration information is not only preserved but is automatically utilized to re-configure the self-storage facility controller 409 when a fault event occurs that might otherwise significantly impair the functionality of the self-storage facility.

Overlock Control

As mentioned earlier, overlooks provide an ability for facility management to lock a given self-storage unit's movable barrier in a closed position regardless of whether the end user-controllable lock is removed by the end user. Such a capability permits a given self-storage unit to be secured for any number of facility management purposes such as, but not limited to, securing unrented units, securing units for end users who are in arrears with respect to their rental payments, and so forth. It is possible to configure these overlooks to respond to remote control signals as sourced from a central location such as a self-storage facility office. Such an approach, of course, corresponds well to the present teachings.

Overlocking, however, presents certain risks as well as benefits. There are, for example, certain secondary influences that can prevent an overlock from being switched from a locked state. (As used herein, the expression “secondary influences” will be understood to refer to causes and stimuli other than facility management instructions or end user instructions.) Examples in this regard include certain weather conditions such as below-freezing temperatures combined with wet conditions that can lead to ice that forms on and/or in the overlock mechanism.

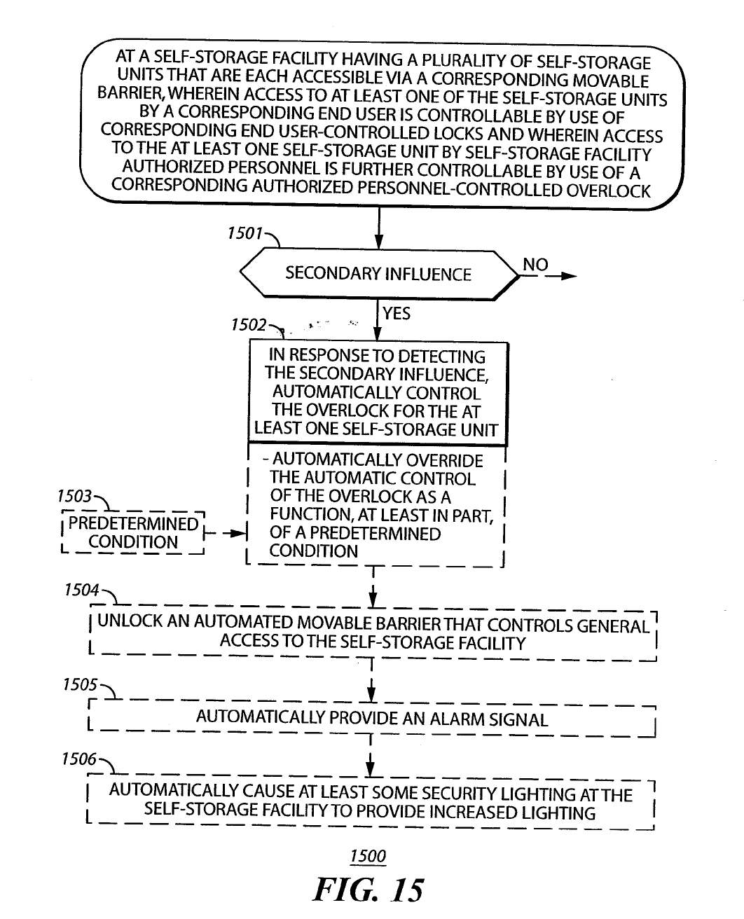

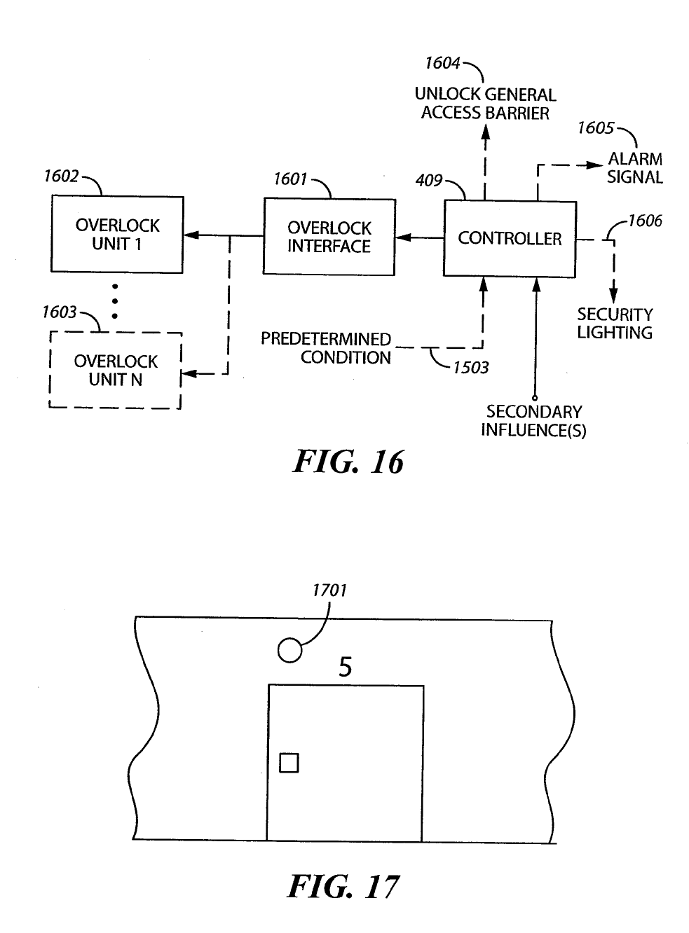

Referring now to FIGS. 15 and 16, a process 1500 and a corresponding apparatus will be described to address these circumstances. This process 1500 can be carried out in conjunction with a self-storage facility as described above wherein the facility includes overlooks that can be controlled by corresponding authorized personnel for the facility to thereby further control access to the self-storage units as comprise the facility. In this illustrative embodiment, this process 1500 can be carried out via the aforementioned controller 409. To facilitate this, the controller 409 can operably couple to one or more of the overlooks 1602, 1603 via a corresponding overlock interface 1601. By one approach, this overlock interface 1601 can comprise, in whole or in part, the aforementioned communications interface if desired.

This process 1500 provides the step 1501 of detecting a secondary influence (or influences) of choice. Generally speaking, this secondary influence comprises an influence that is capable of interfering with the operational functionality of the overlocks. Accordingly, generally speaking, this step 1501 of detecting a secondary influence comprises receiving information that relates, directly or indirectly, to the operational functionality of one or more of the overlocks.

By one approach, this can comprise detecting one or more weather conditions of interest. In particular, this can comprise detecting weather conditions that are capable of causing an overlock to persist a given lock state. (This notion of persisting will be understood to include both continuous persistence as well as intermittent persistence.) Illustrative examples in this regard include, but are not necessarily limited to, receiving a weather warning via some streaming service (such as the Internet, a television broadcast, or a radio broadcast), receiving a weather forecast via some streaming service, receiving a weather forecast via some polled service, receiving weather information as direct input from an individual (such as personnel at the self-storage facility, personnel for a contracted third party service provider, or the like), and so forth.

The presence of a secondary influence can also be detected, if desired, using information regarding the direct operational functionality of one or more of the overlocks. Information regarding a power source that provides operating electricity to a given overlock, for example, can serve in this regard. For example, an indication that remaining battery capacity is drawing low or that battery status (such as battery voltage) is poor, hence threatening the future ability of the corresponding overlock to switch to an unlocked state, can serve to trigger the detection of a secondary influence.

Other possibilities exist in these regards as well. For example, by one approach, the controller 409 (or a surrogate on behalf of the controller 409) can maintain a count of how many times each overlock is cycled between a locked and unlocked state. A secondary influence of concern can then be considered detected when the number of times that the overlock has been employed exceeds some predetermined threshold. (As used herein, the expression “predetermined” will be understood to refer to a determination that well precedes, both in time and in terms of executed functionality, the point in time when the corresponding determined value is utilized as described. A determination that occurs during the course of this described process, then, does not comprise a predetermination by this point of view.)

Yet another example in these regards might comprise detecting the presence of public-safety personnel (such as firefighters, police, and other official first responders) at the self-storage facility. The presence of such personnel may be detected, for example, by a particular code or key that such personnel employ at the point of entry for the self-storage facility. It may be desirable, for example, to unlock all locked overlooks when such persons are at the facility in order to not potentially impede the purpose of their visit.

This process 1500 then provides the step 1502 of automatically responding to the detecting of this secondary influence by automatically controlling one or more of the facility's overlooks. This can comprise, for example, automatically placing the overlock into an unlocked state. This step can also comprise, if desired, other corresponding actions of choice.

This step 1502 can comprise, if desired, only controlling specific overlooks for which the secondary influence seems relevant. Such an approach may be particularly appropriate when the secondary influence tends by its nature to be specific to given overlooks rather than a general influence that might be expected to influence all of the facility's overlooks. By another approach, however, this step 1502 can comprise controlling all of the facility's overlooks. The latter can be appropriate, for example, when the secondary influence comprises one that holds at least some possibility of affecting all (or substantially all) of the facility's overlocks.

If desired, this process 1500 will optionally accommodate automatically overriding this automated control of the overlooks. This overriding action can itself comprise a function, at least in part, of detecting a predetermined condition 1503. By one approach, for example, this predetermined condition 1503 can comprise a temporal condition (such as a time of day, a day of the week, a date, or the like). By this approach, for example, the step of automatically unlocking overlooks can be overridden during the middle of the day when self-storage facility personnel are expected to be present and available to address a circumstance such as an overlock that is frozen in a locked state.

By another approach, this predetermined condition 1503 can comprise the presence of a person. This might comprise, for example, detecting the presence of authorized personnel for the self-storage facility in the facility office or generally on the grounds. This detection might be based, for example, upon the authorized person having entered a particular code when entering the facility or upon an identifying radio frequency identifier (RFID) badge worn or carried by the authorized person. As another example, an authorized person comprising public safety personal might be identified by activation of their public safety radio transmitters. By another approach, this can comprise detecting the presence of public safety personnel on the premises of the facility. By yet another approach, this can comprise detecting that a person is presently located inside of a given self-storage unit. A detection such as this can be based upon readings from a person sensor (such as a passive infrared detector (PIR) or the like) that is located in this particular self-storage unit.

This process 1500 will also accommodate the optional step 1504 of also unlocking an automated movable barrier that controls general access to the self-storage facility (for example, by transmitting a corresponding remote control signal 1604). Such an action may be appropriate when the secondary influence also presents the potential of causing the point-of-entry barrier to become locked or stuck in a closed position.

Somewhat similarly, this process 1500 will also accommodate the optional step 1505 of automatically providing an alarm signal 1605 in response to detecting the secondary influence. This alarm can comprise a general alarm or can comprise an alert having a form that is unique to this particular stimulus. By one approach, for example, this alarm signal 1605 can comprise a signal that is rendered perceptible in an office at the self-storage facility (audibly, haptically, and/or visually, for example). By another approach, alone or in conjunction with the foregoing, this alarm signal 1605 can comprise a message that is transmitted to authorized personnel for the self-storage facility and/or to some third party service provider of choice. This message can comprise, for example, a text message to inform the recipient of the secondary influence and/or the automatic unlocking of previously locked overlocks.

Automatically unlocking locked overlooks, of course, raises a potential security issue (at least under some operating conditions). With this in mind, this process 1500 will also accommodate the optional step 1506 of also automatically causing at least some security lighting at the self-storage facility to provide increased lighting (by increasing the light provided by dimmed lights, for example, or by bringing additional lights on line). This increased security lighting, for example, can be generally applied to the entire facility or only in areas that contain a now automatically-unlocked overlock. If desired, and referring momentarily to FIG. 17, this can comprise illuminating a specific light 1701 disposed proximal to affected overlooks to indicate the unlocked state of the overlock. Referring again to FIGS. 15 and 16, this step 1506 can comprise, at least in part, issuing one or more corresponding lighting control signals 1606 from the controller 409.

So configured, automatically operated overlooks at a self-storage facility can be employed with a reduced concern that such overlooks will remain inappropriately locked notwithstanding the presence of secondary influences that might otherwise influence such an overlock to persist a locked state even when otherwise inappropriate.

Lighting Control

As already noted, a self-storage facility can comprise a large number of self-storage units. This can presently easily number in the hundreds of units for a single facility. Furthermore, the automated capabilities described herein present a very real opportunity to leverage a very small personnel presence to achieve significant economies of scale by increasing the number of supported self-storage units even further.

As such facilities grow in size, however, various other concerns can arise. For example, it can become difficult for the end users to readily locate their particular self-storage unit when visiting the facility. It can be a source of end-user dissatisfaction for the end user to effectively become lost within such a facility and this also comprises a potential source of security concerns as well. Such difficulties can be particularly acute in large indoor facilities and at night in large outdoors facilities.

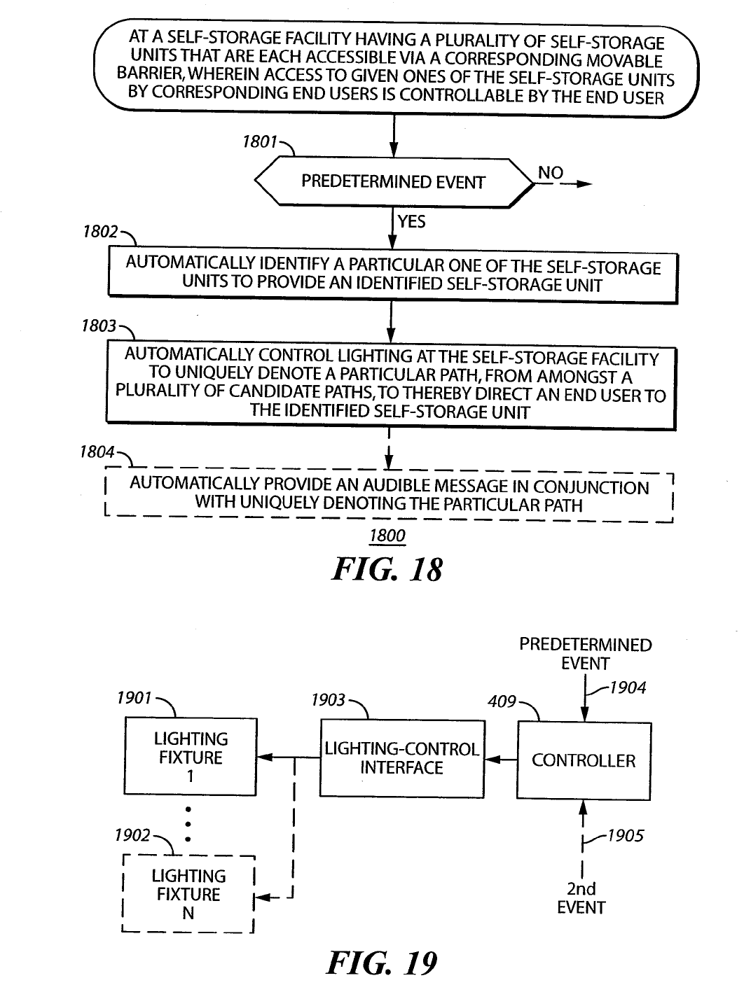

Referring now to FIGS. 18 and 19, a process 1800 and corresponding apparatus will be presented to address such concerns. This process 1800 is shown in conjunction with a facility controller 409 that operably couples to the lighting fixtures 1901, 1902 via, for example, a lighting control interface 1903. By one approach, this lighting control interface 1903 can be realized via the communication interfaces described earlier. So configured, the controller 409 is able to control the illumination state of these lighting fixtures 1901, 1902 in support of these teachings.

This illustrative process 1800 is carried out, in this illustrative example, by appropriate corresponding programming of the controller 409. This process 1800 includes the step 1801 of automatically detecting when a predetermined event 1904 occurs. This can comprise, for example, detecting the presence of a particular end user of the self-storage facility (for example, at a point of entry for the facility). By one approach, this can comprise receiving at least one credential as corresponds to this particular end user. Such a credential can be entered via an appropriate user interface at the point of entry for the facility (such as a keypad, a microphone, a fingerprint reader, and so forth). The credential itself can vary with the needs and/or opportunities as tend to characterize a given application setting. Examples include, but are not limited to, a Personal Identification Number (PIN), a Radio Frequency Identification (RFID) tag (as may be concealed, for example, within a facilities badge or entry card), a wirelessly transmitted signal from, for example, a handheld transmitter, a properly programmed Personal Digital Assistant (PDA), cellular telephone, or the like, a biometric identifier such as a fingerprint, a retinal pattern, a keyboard usage pattern, handwriting recognition, speaker recognition, and so forth, to note but a few examples in these regards.

This process 1800 then provides the step 1802 of automatically identifying a particular one of the self-storage units to provide an identified self-storage unit. This identified self-storage unit will typically correlate to the earlier-detected end user. This correlation can typically be based upon looking up the self-storage unit that has been assigned to the person who is associated with the aforementioned credentials.

Using this information, the process 1800 then effects the step 1803 of automatically controlling lighting at the self-storage facility to uniquely denote a particular path, from amongst a plurality of candidate paths, to thereby direct this end user to the identified self-storage unit. There are numerous ways by which such an activity can be realized. By one approach, for example, this can comprise causing at least some lights, other than those lights that serve to illuminate the particular path, to be at least dimmed to thereby contribute to highlighting the particular path. Using this approach, while lights that pertain to the particular path remain illuminated other lights are dimmed or extinguished to thereby make the particular path clearly stand out.

By another approach, alone or in combination with the approach just described, this step 1803 can comprise causing at least some lights to specifically provide light that serves to illuminate the particular path to thereby contribute to highlighting the particular path. In either of these approaches the lights being controlled in this manner can comprise lighting that is ordinarily used for security lighting, work area lighting, or the like. It is also possible, however, for some or all of the lights used in this manner to comprise lights that are only used for this particular purpose of uniquely denoting the particular path.

In either of these approaches, the lighting utilized can either provide light of a fairly constant intensity (over time) or a more dynamic modification of the brightness levels being provided by the lighting can be employed. This can comprise, by one approach, simply switching at least some of the lights on and off. Depending upon the application setting, this can comprise, if desired, switching the lights on and off in a sequential pattern that leads and directs the end user to the identified self-storage unit. These teachings will also accommodate using an aimable, directable light (such as a light that is movable in a particular way by one or more corresponding servo mechanisms). Such an automatically moving light can serve as well to uniquely denote the particular path for the end user.

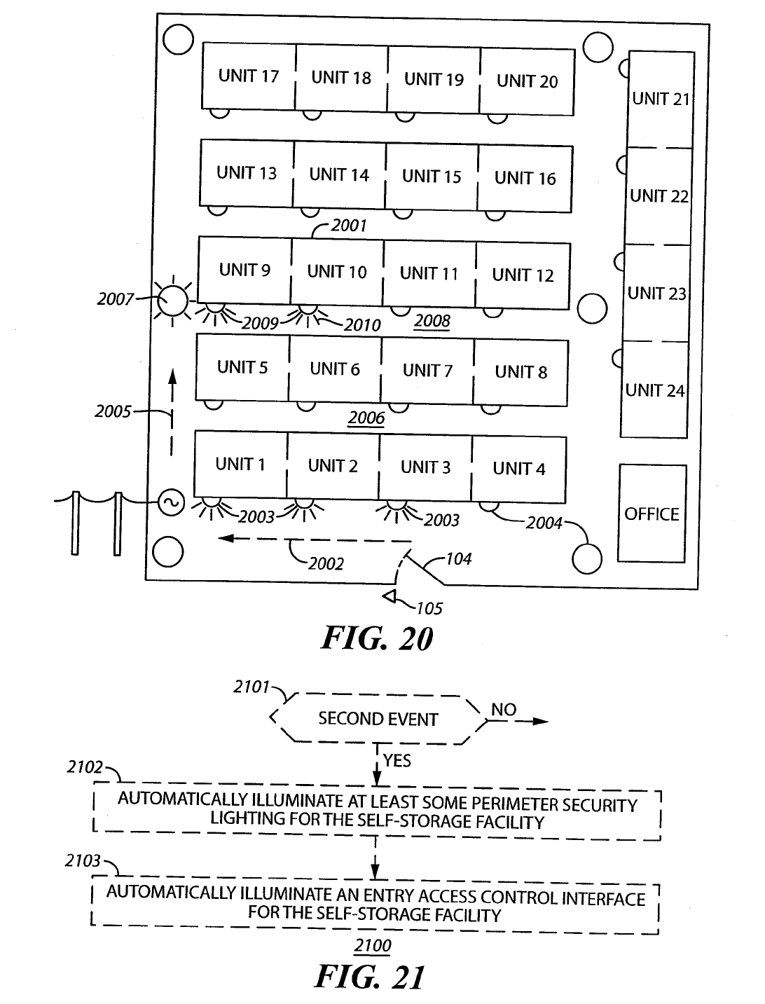

Referring now momentarily to FIG. 20, a simple, illustrative example in these regards will be provided. Those skilled in the art will recognize and understand that the specifics of this example serve an illustrative purpose only and are not offered with any suggestion or intent that these specifics comprise an exhaustive listing of all such possibilities in this regard.

In this example, an end user has presented themselves at the self-storage facility point-of-entry movable barrier 104 and has presented their identifying credentials at an access-control user interface 105. In this illustrative example, the controller determines that this end user corresponds to self-storage unit number 10 (as denoted by reference numeral 2001). There are a number of routes by which this end user can reach this self-storage unit 2001. Initially, for example, one can turn either to the right or to the left. From amongst these candidate pathways the controller uses a particular path 2002 that leads initially to the left.

To uniquely denote this particular path 2002 (and particularly to distinguish from the alternative candidate path that would lead to the right) the controller causes the three lights denoted by reference numeral 2003 to begin blinking intermittently in a sequential pattern that “points” or leads to the left. In addition, the controller dims (for example, by half) other lights (as denoted by reference numeral 2004) that are not associated with the particular path 2002 to thereby further diminish the intuitive appeal of traveling to the right rather than to the left.

As the end user turns the corner and now follows the particular path 2005 down the side of the facility, the lights in a corridor 2006 that offers another candidate pathway are also dimmed by one half to again aid in uniquely identifying the correct path to the end user's self-storage unit. In addition, the security lighting 2007 in the background is blinking between a full-intensity brightness and a half-intensity brightness to aid in drawing the end user forward along the particular path 2005.

As the end user follows this particular path 2005 and reaches the corridor 2008 that includes self-storage unit 10, sequentially blinking lights 2009 are again employed to lead the end user into and down this corridor 2008. In addition, in this illustrative example, the particular light 2010 that corresponds to the end user's unit 2001 is blinking at a different rate than the other blinking lights. For example, the destination light 2010 can be blinking at twice the rate at which the other blinking lights are blinking.

Again, those skilled in the art will recognize that the specifics of this example are intended to serve in only an illustrative manner and that numerous other possibilities exist in these regards. As but one example in this regard, green and red lights can be used to indicate directions in which the end user should travel and directions in which the end user should not be traveling, respectively.

As the person skilled in the art will recognize and understand, the employment of such lighting tends to create a highly intuitive environment that is easily interpreted and followed by even a completely untrained end user who is new to the facility. If desired, however, instructions can be provided to the end user (for example, at the point of entry) regarding at least some of the specifics of such an approach and behaviors to exhibit to best take advantage of the uniquely denoted pathway to their unit. If desired, this can optionally comprise the step 1804 of automatically providing an audible message in conjunction with uniquely denoting the particular path. This audible message can comprise stored content that provides instructions regarding use of the lighting to follow the particular path. If desired, the end user's preferred language can be of record to permit audible instructions in that language to be recalled from storage and played for these purposes.

In the examples provided above, the particular pathway corresponds to a unit as correlates to a given end user. Other possibilities exist, however. For example, the predetermined event can comprise the arrival of public safety personnel at the facility. In this case, the process 1800 may provide for identifying each self-storage unit that corresponds to an end user who is presently visiting the self-storage facility to thereby provide a plurality of identified self-storage units. This process 1800 can then provide for automatically controlling the lighting to uniquely denote particular paths (at the same time or in seriatim fashion as desired) that will direct the public safety personnel to these self-storage units. This can greatly reduce the time that might be required, for example, when first responders are responding to a 911 medical emergency call from an end user visiting their unit at the facility.

Referring now to FIG. 21, these teachings will also optionally accommodate a somewhat corresponding process 2100 that provides the step 2101 of automatically detecting a second event (such as, for example, the approach of a vehicle to the self-storage facility). When this occurs, this process 2100 will then optionally provide the step 2102 of automatically illuminating at least some perimeter security lighting for the self-service facility. This process 2100 can also optionally provide the step 2103 of automatically illuminating an access control interface for the self-storage facility to thereby assist the approaching driver in finding and/or using this access control interface. Such a process 2100 can be rendered subservient, if desired, to an ambient light sensor such that these actions only occur during the evening hours and not during daylight hours.

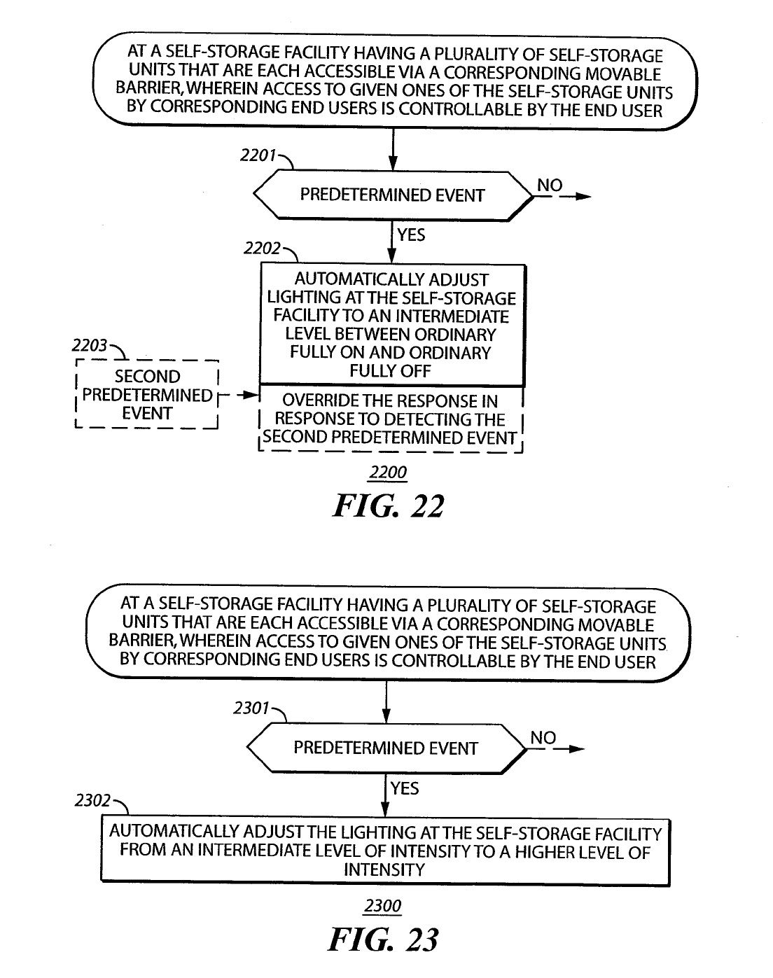

As another somewhat-related optional approach, and referring now to FIG. 22, these teachings will also optionally accommodate a process 2200 that includes the step 2201 of automatically detecting a predetermined event (such as, for example, a particular time of day or the presence of an end user) followed by the responsive step 2202 of automatically adjusting lighting at the self-storage facility to an intermediate level between ordinary full on and ordinary full off. (As used herein, the expression “full on” refers to a light's ordinary maximum intensity and the expression “full off” refers to a light being completely off and outputting no light whatsoever.) In some cases this may comprise adjusting the lighting by increasing the lighting intensity and in other cases this may comprise adjusting the lighting by decreasing the lighting intensity.

To illustrate by way of example, when the predetermined event comprises an end user being present (for example, upon being detected when the end user accesses a point of entry to the self-storage facility or upon detecting a presentation of at least one credential as corresponds to the end user at a point of entry to the self storage facility), this process 2200 can provide for automatically adjusting lighting at the self-storage facility by adjusting the intensity upwards to a given intermediate level.

If desired, this process 2200 will also optionally accommodate overriding the aforementioned response upon detecting a second predetermined event 2203. This second predetermined event can comprise, for example, the presence of an end user (detected, for example, by use of one or more of a motion detecting camera, a passive infrared detector, an active photobeam system, sound detection, an ultrasound-based motion detector, or the like).

To illustrate by way of example, when the predetermined event comprises a particular time of day such as 9 PM and the second predetermined event comprises detecting the presence of an end user, this process 2200 can provide for reducing somewhat the intensity of the lighting at 9 PM unless an end user is in the vicinity, in which case the lighting can remain as it was.

As yet another specific optional approach in these regards, and referring now to FIG. 23, a corresponding process 2300 can provide the step 2301 of automatically detecting a predetermined event followed by the responsive step 2302 of automatically adjusting the lighting at the self-storage facility from an intermediate level of intensity to a higher level of intensity. By one approach, this higher level of intensity does not comprise a maximum possible level of intensity that the light is ordinarily capable of outputting.

Facility Cameras

Various of the embodiments noted above have made occasional reference to the use of one or more cameras at the self-storage facility. So-called closed-circuit digital cameras can provide numerous benefits and opportunities with respect to enhancing the overall security of such a facility. Generally speaking, however, these cameras require a significant amount of local lighting in order to properly illuminate the subject matter to permit capturing clear and distinct images of that subject matter. Motion detection (achieved via use of a camera) also often requires properly illuminating the subject matter but may not require as much illumination as when seeking to capture a clear and distinct image. As the number of cameras being used increases, so to does the corresponding expenditure of energy to ensure the provision of this sufficient amount of lighting.

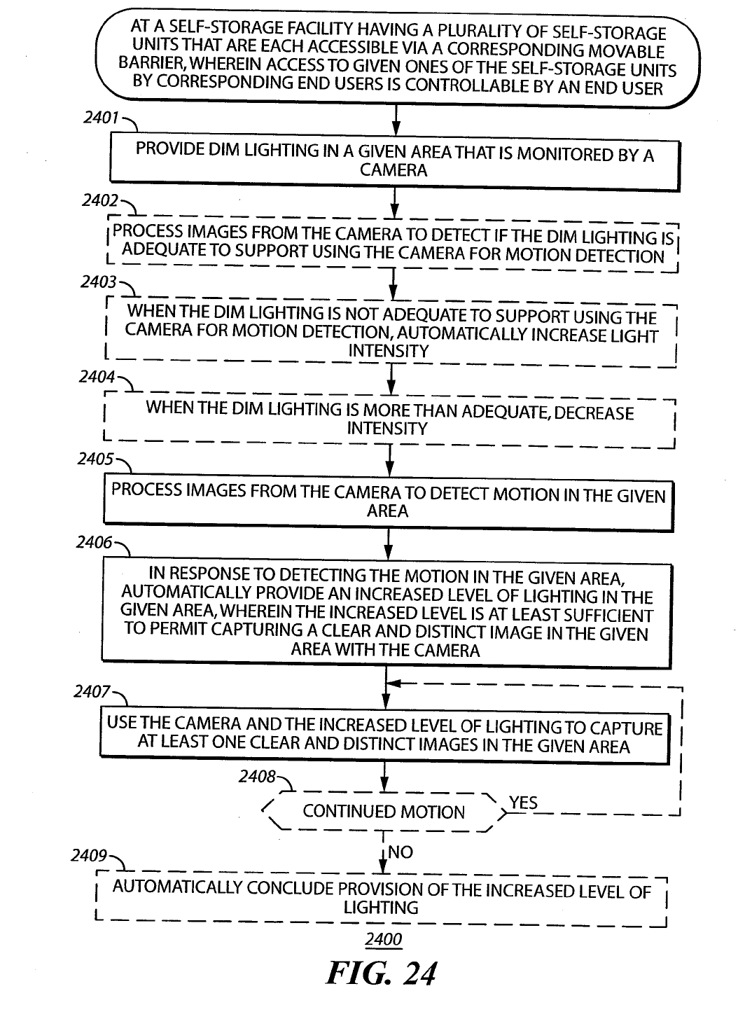

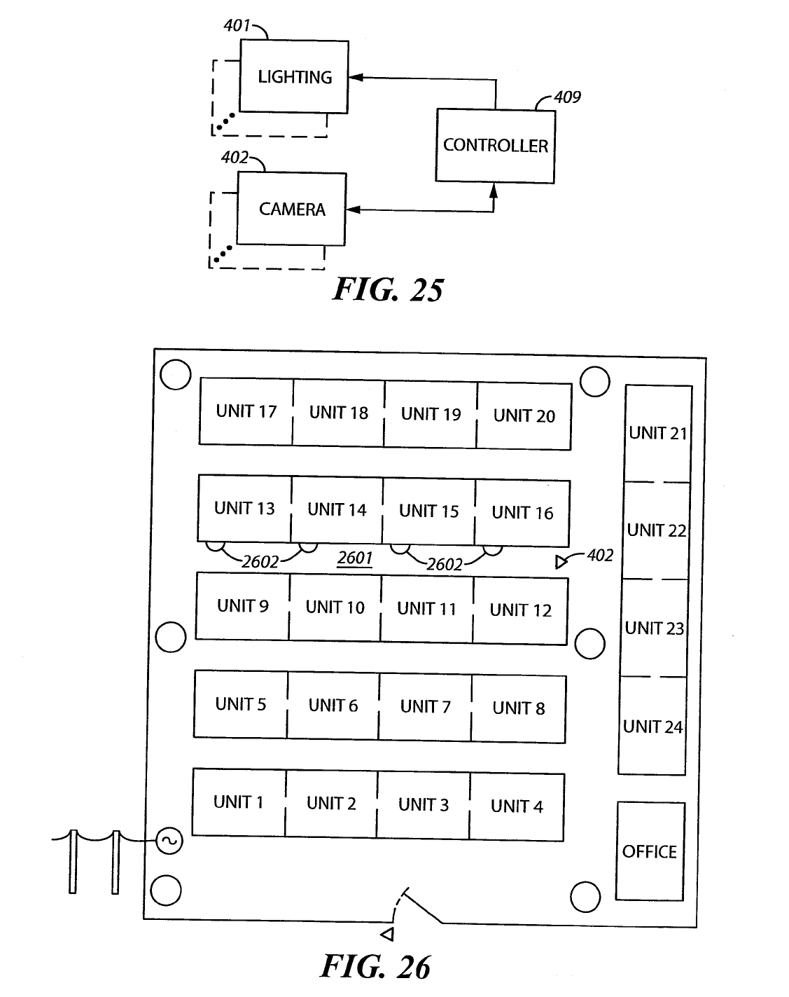

Referring now to FIGS. 24 and 25, a description of a process 2400 and a corresponding apparatus to address this concern will be provided. This description presumes the availability of a controller 409 that operably couples to one or more lights 401 and one or more cameras 402. This coupling can be realized using one or more of the networks described above.

This particular illustrative process 2400 provides the step 2401 of providing dim lighting in a given area that is monitored by a camera. As used herein, it will be understood that “dim lighting” refers to an amount of lighting that is insufficient to permit capturing a clear and distinct image with the camera but that is sufficiently bright to illuminate an object in the area for the purposes of motion detection via the cameras. This dim lighting can be provided using lights that only provide dim illumination or by using lights that are capable of providing greater illumination but that have been dimmed. This process 2400 will also accommodate using only one or a few lights which, even though they are possibly providing as much brightness as they are capable of, still only results in dim lighting.

This process 2400 can optionally provide the step 2402 of processing images from the camera to thereby detect whether the dim lighting is in fact sufficient to support detecting motion in the given area and then, which such is not the case, providing the step 2403 of automatically increasing light intensity to permit such motion detection while still nevertheless providing only dim illumination. By one approach, this can comprise causing lights that are providing the dim illumination to themselves provide an increased level of lighting. By another approach, alone or in conjunction with the foregoing, this can comprise supplementing the lights that are providing the dim lighting with additional lighting.

As another related response in these regards, this process 2400 can also optionally provide the step 2404 of automatically decreasing the intensity of the lighting (to yield even dimmer illumination) when the dim lighting is more than adequate to support using the camera for motion detection.

In any event, another step 2405 supported by this process 2400 comprises processing images from the camera to thereby detect when motion occurs in the given area. This can comprise, for example, processing images that are captured on some regular (or irregular) basis (such as, for example, two images captured in short succession to one another once every minute, once every five minutes, and so forth as desired). By one approach, the aforementioned controller 409 can be configured to effect such an activity. (There are various approaches known in the art to detect motion based upon comparisons between subsequent images. As the present teachings are not particularly sensitive to choices made in this regard, for the sake of brevity further elaboration in these regards will not be presented here.)

When this step 2405 reveals motion in the given area, this process 2400 then provides the step 2406 of automatically providing an increased level of lighting in the given area. This increased level of lighting shall be sufficient to permit capturing a clear and distinct image in the given area with the camera. As used herein, this reference to a “clear and distinct image” shall be understood to refer to a high signal-to-noise image that is non-grainy and that has a good contrast ratio in degrees sufficient to permit a person's face appearing in the image to be used to establish a reliable personal identification of that person.

This increased level of lighting can again be achieved in any of a variety of ways. This can include supplementing the lighting that is providing the dim lighting and/or using the lights that are providing the dim lighting to themselves provide the increased level of lighting. Those skilled in the art will understand, however, that this increased level of lighting is not the result of using a strobe or flash as is sometimes used in photography to illuminate the subject. (Notwithstanding the foregoing, however, these teachings may of course be implemented in conjunction with the use of strobe/flash lighting techniques if desired.)

Having increased the lighting in step 2406, this process 2400 then provides the step 2407 of using the camera and the increased level of lighting to capture at least one clear and distinct image in the given area. That image can then be stored, if desired, for later reference. It would also be possible to display that image on a display in the office of the self-storage facility (or elsewhere in the self-storage facility) to permit on-site authorized personnel to view the image and assess whether the detected motion and the source of that motion (as is presumably disclosed by the image itself) warrants their further attention. And, if desired, it would also be possible to forward this image to authorized personnel, authorized service providers, a renter of the storage location, or first responders via, for example, email or the like.

If desired, this process 2400 will optionally accommodate the step 2408 of determining whether the detected motion persists. When true, by one approach, this process 2400 can provided for capturing, again, another corresponding clear and distinct image as per step 2407. When the motion goes undetected (say, for some period of time such as ten seconds, half a minute, five minutes, or the like), this process 2400 can then provide the step 2409 of automatically concluding the aforementioned provision of increased lighting levels in the given area.

Referring now to FIG. 26, a simple illustrative example in these regards will be provided. Those skilled in the art will recognize and understand that the specifics of this example serve an illustrative purpose only and are not offered with any suggestion or intent that these specifics comprise an exhaustive listing of all such possibilities in this regard.

In this example, a digital camera 402 is positioned to have a field of view comprising a corridor 2601. Lights 2602 are provided for each self-storage unit (these being units 13 through 16 in this example). These lights 2602 have corresponding intensities that are controllable over some range from very dim to fully on by the facility controller (not shown in this figure). At the beginning of this example, these lights 2602 are all on, albeit at a low level such that only dim illumination exists in this corridor 2601.

If and when a person (not shown) enters the corridor 2601, the controller will be able to make comparative use of images being provided by the camera 492 to thereby detect the movement of that person. The controller then causes the lights 2602 to become more brightly illuminated, thereby making it possible for the camera 402 to capture one or more clear and distinct images of this person. When that person eventually leaves this corridor 2601, the lack of motion can be eventually detected and the lighting 2602 returned to the original state of dimness.

System Integration

Those skilled in the art will recognize and appreciate that the various teachings presented herein are quite capable of being combined with one another in any number of ways and permutations. The particular configuration selected in a given instance will likely vary with the needs and/or opportunities that tend to characterize a given application setting. Generally speaking, these teachings can contribute in various ways to economies of scale and scalability, reductions in necessary capital (both to initially build such a facility and to operate and maintain such a facility), security, reduced personnel requirements, reliability, flexibility, managerial effectiveness, and end user satisfaction.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a self-storage facility having a plurality of self-storage units that are each accessible via a corresponding movable barrier, wherein access to given ones of the self-storage units by corresponding end users is controllable by use of corresponding end user-controlled locks, and wherein the self-storage facility comprises at least three facility components selected from the categories of:
area lighting;
security cameras;
self-storage unit movable barrier overlocks;
a movable barrier at a point of entry for the self-storage facility;
sensors;
wireless data radios;
that require electrical power:
coupling the facility components to an electric mains to provide operating electrical power;
automatically sensing a lack of electrical power via the electric mains;
in response to detecting the lack of electrical power, automatically:
actuating a back-up generator to provide back-up electrical power;
providing the back-up electrical power to at least some of the facility components.

2. The method of claim 1 wherein the self-storage facility comprises at least four facility components selected from the categories of:
area lighting;
security cameras;
self-storage unit movable barrier overlocks;
a movable barrier at a point of entry for the self-storage facility;
sensors;
wireless data radios;
that require electrical power.

3. The method of claim 1 wherein the self-storage facility comprises facility components selected from each of the categories of:
area lighting;
security cameras;
self-storage unit movable barrier overlocks;
a movable barrier at a point of entry for the self-storage facility;
sensors;
wireless data radios;
that require electrical power.

4. The method of claim 1 wherein providing the back-up electrical power to at least some of the facility components comprises providing the back-up electrical power to each of the facility components.

5. The method of claim 1 wherein actuating a back-up generator to provide back-up electrical power comprises actuating at least a first back-up generator and a second back-up generator.

6. The method of claim 5 wherein providing the back-up electrical power to at least some of the facility components comprises:
providing back-up electrical power from the first back-up generator to a first group of the facility components:
providing back-up electrical power from the second back-up generator to a second group of the facility components that is different from the first group of the facility components.

7. A method comprising:
at a self-storage facility having an electric mains to provide operating electrical power and a plurality of self-storage units that are each accessible via a corresponding movable barrier, wherein access to given ones of the self-storage units by corresponding end users is controllable by use of corresponding end user-controlled locks, and wherein the self-storage facility comprises at least three facility components selected from the categories of:
area lighting;
security cameras;
self-storage unit movable barrier overlocks;
a movable barrier at a point of entry for the self-storage facility;
sensors;
wireless data radios;
that require electrical power and that are operably coupled to the electric mains:
at least one back-up generator;
a controller operably coupled to the back-up generator and being configured to:
automatically sense a lack of electrical power via the electric mains;
in response to detecting the lack of electrical power, automatically:
actuate the back-up generator to provide back-up electrical power;
provide the back-up electrical power to at least some of the facility components.

8. The apparatus of claim 7 wherein the self-storage facility comprises at least four facility components selected from the categories of:
area lighting;
security cameras;
self-storage unit movable barrier overlocks;
a movable barrier at a point of entry for the self-storage facility;
sensors;
wireless data radios;
that require electrical power.

9. The apparatus of claim 7 wherein the self-storage facility comprises facility components selected from each of the categories of:
area lighting;
security cameras;
self-storage unit movable barrier overlocks;
a movable barrier at a point of entry for the self-storage facility;
sensors;
wireless data radios;
that require electrical power.

10. The apparatus of claim 7 wherein the controller is configured to provide the back-up electrical power to at least some of the facility components by providing the back-up electrical power to each of the facility components.

11. The apparatus of claim 10 wherein the controller is configured to provide the back-up electrical power to at least some of the facility components by:
providing back-up electrical power from a first back-up generator to a first group of the facility components:
providing back-up electrical power from a second back-up generator to a second group of the facility components that is different from the first group of the facility components.

12. A method comprising:
at a self-storage facility having a plurality of self-storage units that are each accessible via a corresponding movable barrier, wherein access to given ones of the self-storage units by corresponding end users is controllable by the end user, and wherein the self-storage facility comprises at least three facility components selected from the categories of:
area lighting;
security cameras;
self-storage unit movable barrier overlocks;
a movable barrier at a point of entry for the self-storage facility;
sensors;
wireless data radios;
that require electrical power:
providing a renewable electrical energy source at the self-storage facility;
using the renewable electrical energy source to provide the electrical power to the at least three facility components.

13. The method of claim 12 wherein the renewable electrical energy source comprises a photonically-based renewable electrical energy source.

14. The method of claim 12 wherein the renewable electrical energy source comprises a wind-based renewable electrical energy source.

15. The method of claim 12 wherein using the renewable electrical energy source to provide the electrical power to the facility components comprises storing energy from the renewable electrical energy source in at least one battery and selectively coupling the battery to the facility components.

16. The method of claim 15 further comprising:
coupling the facility components to an electric mains to provide operating electrical power to the facility components;
and wherein using the renewable electrical energy source to provide the electrical power to the facility components comprises automatically sensing a lack of electrical power via the electric mains and, in response to detecting the lack of electrical power via the electric mains, selectively coupling the battery to the facility components.

17. The method of claim 16 wherein the operating electrical power from the electric mains does not charge the battery.

18. An apparatus comprising:
at a self-storage facility having a plurality of self-storage units that are each accessible via a corresponding movable barrier, wherein access to given ones of the self-storage units by corresponding end users is controllable by the end user, and wherein the self-storage facility comprises at least three facility components selected from the categories of:
area lighting;
security cameras;
self-storage unit movable barrier overlooks;
a movable barrier at a point of entry for the self-storage facility;
sensors;
wireless data radios;
that require electrical power:
a renewable electrical energy source at the self-storage facility;
a controller that is operably coupled to the renewable electrical energy source and that is configured to use the renewable electrical energy source to provide the electrical power to the at least three facility components.

19. The apparatus of claim 18 wherein the renewable electrical energy source comprises a photonically-based renewable electrical energy source.

20. The apparatus of claim 18 wherein the renewable electrical energy source comprises a wind-based renewable electrical energy source.

21. The apparatus of claim 18 wherein the controller is configured to use the renewable electrical energy source to provide the electrical power to the facility components by storing energy from the renewable electrical energy source in at least one battery and selectively coupling the battery to the facility components.

22. The apparatus of claim 21 wherein:
the facility components are coupled to an electric mains to provide operating electrical power to the facility components;
and wherein the controller is configured to use the renewable electrical energy source to provide the electrical power to the facility components by automatically sensing a lack of electrical power via the electric mains and, in response to detecting the lack of electrical power via the electric mains, selectively coupling the battery to the facility components.

23. The apparatus of claim 22 wherein the operating electrical power from the electric mains does not charge the battery.

24. A method comprising:
at a self-storage facility having a plurality of self-storage units that are each accessible via a corresponding movable barrier, wherein access to given ones of the self-storage units by corresponding end users is controllable by the end user, and wherein the self-storage facility comprises at least three facility components selected from the categories of:
area lighting;
security cameras;
self-storage unit movable barrier overlocks;
a movable barrier at a point of entry for the self-storage facility;
sensors;
wireless data radios;
that require electrical power:
providing a source of direct current electrical power;
coupling the source of direct current electrical power to the facility components to provide the electrical power required by the facility components.

25. The method of claim 24 wherein the self-storage facility comprises at least four facility components selected from the categories of:
area lighting;
security cameras;
self-storage unit movable barrier overlooks;
a movable barrier at a point of entry for the self-storage facility;
sensors;
wireless data radios;
that require electrical power.

26. The method of claim 24 wherein the self-storage facility comprises facility components selected from each of the categories of:
area lighting;
security cameras;
self-storage unit movable barrier overlooks;
a movable barrier at a point of entry for the self-storage facility;
sensors;
wireless data radios;
that require electrical power.

27. The method of claim 24 wherein the source of direct current electrical power comprises a source of 48 volt direct current electrical power.

28. The method of claim 24 wherein the self-storage facility lacks an electric mains.

29. An apparatus comprising:
at a self-storage facility having a plurality of self-storage units that are each accessible via a corresponding movable barrier, wherein access to given ones of the self-storage units by corresponding end users is controllable by the end user, and wherein the self-storage facility comprises at least three facility components selected from the categories of:
area lighting;
security cameras;
self-storage unit movable barrier overlocks;
a movable barrier at a point of entry for the self-storage facility;
sensors;
wireless data radios;
that require electrical power:
a source of direct current electrical power that operably couples to the at least three facility components to provide the electrical power required by the at least three facility components.

30. The apparatus of claim 29 wherein the self-storage facility comprises at least four facility components selected from the categories of:
area lighting;
security cameras;
self-storage unit movable barrier overlocks;
a movable barrier at a point of entry for the self-storage facility;
sensors;
wireless data radios;
that require electrical power;
and wherein the source of direct current electrical power operably couples to the at least four facility components.

31. The apparatus of claim 29 wherein the self-storage facility comprises facility components selected from each of the categories of:
area lighting;
security cameras;
self-storage unit movable barrier overlocks;
a movable barrier at a point of entry for the self-storage facility;
sensors;
wireless data radios;
that require electrical power;
and wherein the source of direct current electrical power operably couples to each of the facility components.

32. The apparatus of claim 29 wherein the source of direct current electrical power comprises a source of 48 volt direct current electrical power.

33. The apparatus of claim 29 wherein the self-storage facility lacks an electric mains.
